(19) United States
(12) Patent Application Publication
(10) Pub. No.: US 2025/0041790 A1
(43) Pub. Date: Feb. 6, 2025

(54) Gas Separation Apparatus

(71) Applicant: SEIKO EPSON CORPORATION, Tokyo (JP)

(72) Inventor: Satoru FUKUI, Chino (JP)

(21) Appl. No.: 18/788,263

(22) Filed: Jul. 30, 2024

(30) Foreign Application Priority Data
Jul. 31, 2023 (JP) 2023-124591

(51) Int. Cl. B01D 53/22

(52) U.S. Cl. CPC B01D 53/22; B01D 2053/222; B01D 2257/504

(57) ABSTRACT

A gas separation apparatus includes a first gas chamber including: a first wall part configured to define a first space, a mixed gas supply port, and a mixed gas discharge port; a second gas chamber including a second wall part configured to define a second space, and a gas component discharge port that is configured to discharge a predetermined gas component; and a rotary fan including a base part that is hollowed, that is configured to rotate around a rotation axis, a vane part that is hollowed, that is disposed in the first space, and a first gas separation membrane that is configured to separate an inside and an outside of the vane part, and that allows the predetermined gas component to permeate therethrough.

The present application is based on, and claims priority from JP Application Serial Number 2023-124591, filed Jul. 31, 2023, the disclosure of which is hereby incorporated by reference herein in its entirety.

### BACKGROUND

### 1. Technical Field

The present disclosure relates to a gas separation apparatus.

### 2. Related Art

In order to implement carbon neutrality or carbon minus, a technique is being considered to absorb and collect carbon dioxide discharged from thermal power plants, boiler facilities, or the like, and carbon dioxide in the atmosphere. As such a technique, there has been known a membrane separation method of separating carbon dioxide using a gas separation membrane.

For example, JP-A-2021-133354 discloses carbon dioxide recovery apparatus including a first separation unit that is disposed to separate a first supply space and a first processing space, and that separates carbon dioxide contained in a material gas supplied to the first supply space from impurity gases containing components other than carbon dioxide out of the material gas by permeation. It is also disclosed that the first separation unit includes a separation membrane through which carbon dioxide contained in the material gas selectively permeates.

JP-A-2021-133354 is an example of the related art.

In the membrane separation method, it is a problem to improve separation efficiency of a predetermined gas component. In order to increase the separation efficiency of the gas separation membrane, it is necessary to keep the concentration of the predetermined gas component at a high level at the upstream of the gas separation membrane. However, when a predetermined gas component permeates the gas separation membrane, the concentration of the gas component at the upstream decreases accordingly, which incurs a decrease in separation efficiency.

Therefore, it is required to realize a gas separation apparatus in which the concentration of the predetermined gas component hardly decreases even when the predetermined gas component permeates the gas separation membrane and a decrease in separation efficiency can be suppressed.

### SUMMARY

A gas separation apparatus according to an application example of the present disclosure includes:

a first gas chamber including a first wall part configured to define a first space, a mixed gas supply port that is provided to the first wall part and configured to supply a mixed gas into the first space, and a mixed gas discharge port configured to discharge the mixed gas from the inside of the first space to an outside;

a second gas chamber including a second wall part configured to define a second space, and a gas component discharge port that is provided to the second wall part and configured to discharge a gas containing a predetermined gas component extracted from the mixed gas from an inside of the second space to an outside; and a rotary fan including a base part that is hollowed, that is configured to rotate around a rotation axis, and that has an inside communicating with the second space, a vane part that is hollowed, that is disposed in the first space, and that has an inside communicating with the second space, and a first gas separation membrane that is configured to separate an inside and an outside of the vane part, and that allows a gas higher in concentration of the predetermined gas component than the mixed gas to permeate therethrough.

### BRIEF DESCRIPTION OF THE DRAWINGS

FIG. 1 is a cross-sectional view illustrating a configuration of a gas separation apparatus according to a first embodiment.

FIG. 2 is a plan view showing a rotary fan provided to the gas separation apparatus in FIG. 1.

FIG. 3 is a graph showing a relationship between the gas permeability to carbon dioxide of a first gas separation membrane and the concentration of carbon dioxide on a surface at a first space side of the first gas separation membrane.

FIG. 4 is a cross-sectional view illustrating a configuration of a gas separation apparatus according to a second embodiment.

FIG. 5 is a cross-sectional view showing a rotary fan provided to the gas separation apparatus in FIG. 4.

FIG. 6 is a cross-sectional view illustrating a configuration of a gas separation apparatus according to a third embodiment.

FIG. 7 is a plan view showing a rotary fan provided to the gas separation apparatus in FIG. 6.

FIG. 8 is a plan view illustrating a rotary fan provided to a gas separation apparatus according to a fourth embodiment.

FIG. 9 is a schematic diagram in which an example of a flow of a mixed gas is added to a cross-sectional view of a vane part shown in FIG. 8.

FIG. 10 is a schematic diagram in which an example of a flow of the mixed gas is added to the cross-sectional view of the model (model of the related-art example) in which convex structures shown in FIG. 9 is omitted.

### DESCRIPTION OF EMBODIMENTS

Hereinafter, a gas separation apparatus according to the present disclosure will be described in detail based on some embodiments illustrated in the accompanying drawings.

### 1. First Embodiment

First, a gas separation apparatus according to a first embodiment will be described.

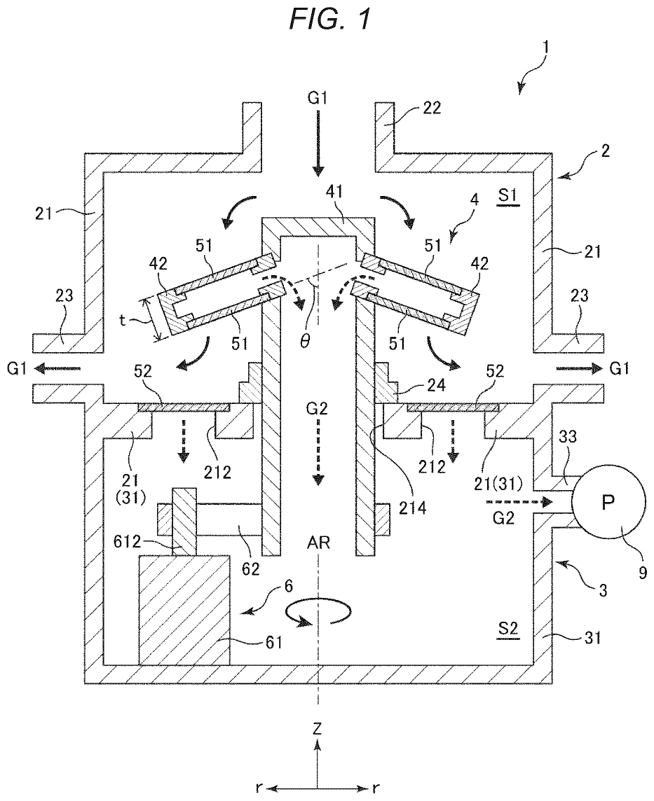

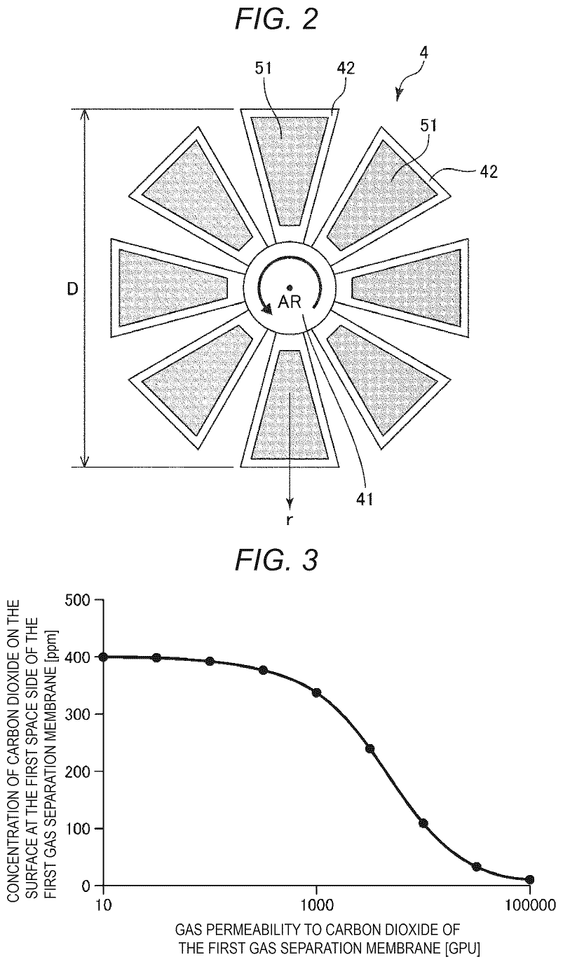

FIG. 1 is a cross-sectional view illustrating a configuration of a gas separation apparatus 1 according to the first embodiment. FIG. 2 is a plan view illustrating a rotary fan 4 provided to the gas separation apparatus 1 in FIG. 1.

In the drawings of the present application, a z axis and an r axis are set. The r axis is an axis representing a radial direction when setting the z axis as the center. Although there is a plurality of r axes radially extending from the z axis, each drawing illustrates one representative r axis or two representative r axes. In addition, in each of the drawings, each axis is represented by an arrow, a tip side of the arrow represents “plus,” and a base end side of the arrow represents “minus.” In the following description, for example, the “z-axis direction” includes both of a positive direction and a negative direction of the z axis. The same applies to the r-axis direction.

### 1.1. Overview

The gas separation apparatus 1 illustrated in FIG. 1 includes a first gas chamber 2, a second gas chamber 3, the rotary fan 4, and an exhaust pump 9.

The first gas chamber 2 has a first space S1. The first space S1 is configured such that a mixed gas G1 passes therethrough. The second gas chamber 3 has a second space S2. The second space S2 is configured such that a mixed gas G2 (gas higher in carbon dioxide concentration than the mixed gas G1) extracted and separated from the mixed gas G1 permeates therethrough. The concentration of carbon dioxide satisfies G1<G2. In the drawings of the present application, the flow of the mixed gas G1 is indicated by a solid arrow, and the flow of the mixed gas G2 is indicated by a dotted arrow.

The mixed gas G1 is a gas that contains carbon dioxide as a gas component as a separation target and other gas components (non-target components). The mixed gas G1 is not particularly limited, and is, for example, the atmosphere, or an exhaust gas discharged from a facility such as a factory. The gas component as the separation target is not limited to carbon dioxide and may be another gas component. The non-target component varies depending on the mixed gas G1, but is nitrogen, oxygen, or the like when the mixed gas G1 is the air.

The rotary fan 4 includes a base part 41 that is hollow, and extends along the z axis, a vane part 42 that is hollow, and is disposed in the first gas chamber 2, and a first gas separation membrane 51 that is provided to the vane part 42. The base part 41 rotates around a rotation axis AR extending in parallel to the z axis, and the inside thereof communicates with the second gas chamber 3. The vane part 42 is supported by the outer side surface of the base part 41, and the inside thereof communicates with the second gas chamber 3. The first gas separation membrane 51 separates the inside (the second space S2) and the outside (the first space S1) of the vane part 42, allows the carbon dioxide contained in the mixed gas G1 in the first space S1 to selectively or preferentially permeate over other gas components, and introduces the mixed gas G2 having a higher carbon dioxide concentration than the mixed gas G1 into the second space S2.

In such the gas separation apparatus 1, as the rotary fan 4 rotates, the vane part 42 having the first gas separation membrane 51 moves in the mixed gas G1. Specifically, the rotary fan 4 generates a gas flow flowing from the z-axis positive side to the z-axis negative side. Therefore, even when the concentration of carbon dioxide on the surface of the first gas separation membrane 51 at the first space S1 side decreases due to an action of the first gas separation membrane 51, the fresh mixed gas G1 can rapidly be supplied to the first gas separation membrane 51 by the gas flow. That is, by moving the vane part 42 to the region where the concentration of carbon dioxide in the mixed gas G1 is not decreased, it is possible to suppress the decrease in the concentration of carbon dioxide on the first gas separation membrane 51. As a result, a decrease in the separation efficiency of carbon dioxide in the first gas separation membrane 51 can be suppressed.

### 1.2. First Gas Chamber

The first gas chamber 2 includes a first wall part 21, a mixed gas supply port 22, and a mixed gas discharge port 23.

An inner wall surface of the first wall part 21 defines the first space S1. The mixed gas G1 is supplied to the first space S1 through the mixed gas supply port 22. The mixed gas G1 thus supplied is moved in the first space S1 by the rotary fan 4 and is discharged to the outside through the mixed gas discharge port 23. In such a manner, the first space S1 controls the flow of the mixed gas G1. A constituent material of the first wall part 21 is not particularly limited, and examples thereof include a resin material, a metal material, and a ceramic material. In addition, a composite material containing these materials may be used.

The first wall part 21 is provided with the mixed gas supply port 22 and the mixed gas discharge port 23. The mixed gas supply port 22 is provided in a region (on an extension line of the rotation axis AR) of the first wall part 21 at the z-axis positive side of the rotary fan 4. Since the mixed gas supply port 22 is provided to such a region, the fresh mixed gas G1 can efficiently be drawn into the first space S1 with the gas flow generated by the rotary fan 4.

The mixed gas discharge port 23 is provided in a region (on a radius of the rotation axis AR) of the first wall part 21 at the r-axis positive side of the rotary fan 4. The radius of the rotation axis AR refers to a half line orthogonal to the rotation axis AR. Since the mixed gas discharge port 23 is provided in such a portion, the mixed gas G1 in which the concentration of carbon dioxide is reduced can efficiently be discharged to the outside of the first space S1 with the gas flow generated by the rotary fan 4.

The mixed gas supply port 22 may be formed of a hole that communicates the first space S1 with the outside or may have a structure to which a pipe (not shown) can be coupled.

The mixed gas discharge port 23 may be formed of a hole that communicates the first space S1 with the outside or may have a structure to which a pipe (not shown) can be coupled.

### 1.3. Second Gas Chamber

The second gas chamber 3 has a second wall part 31 and a gas component discharge port 33.

An inner wall surface of the second wall part 31 defines the second space S2. The carbon dioxide thus separated is supplied to the second space S2. The carbon dioxide thus supplied moves in the second space S2 and is exhausted by the exhaust pump 9 through the gas component discharge port 33. The carbon dioxide thus exhausted is recovered in a recovery unit (not shown). A constituent material of the second wall part 31 is not particularly limited as long as it is a material having rigidity capable of withstanding a pressure difference between the second space S2 and the outside. Examples of the constituent material include a resin material, metal material, and a ceramic material. In addition, a composite material containing these materials may be used.

The gas component discharge port 33 is coupled to the exhaust pump 9 via the pipe. Accordingly, the second space S2 can be depressurized, and the carbon dioxide can be separated. Examples of the exhaust pump 9 include a dry pump such as a screw pump and a scroll pump, an oil rotary pump, and a turbo molecular pump. Among them, the dry pump is preferably used, and the screw pump is more preferably used. These are useful as the exhaust pump 9 because there is no possibility that the second space S2 is contaminated since no oil or liquid is used, and the power consumption is low.

The first wall part 21 and the second wall part 31 are partially integrated. Communication holes 212 and a communication hole 214 that communicate the first space S1 and the second space S2 with each other are provided in this portion.

The communication holes 212 are disposed at regular intervals around the rotation axis AR. The communication holes 212 are closed by second gas separation membranes 52. The second gas separation membranes 52 each separate the second space S2 and the first space S1 from each other, allow carbon dioxide contained in the mixed gas G1 in the first space S1 to selectively or preferentially permeate over other gas components, and introduce the mixed gas G2 higher in carbon dioxide concentration than the mixed gas G1 into the second space S2.

The base part 41 of the rotary fan 4 described later is inserted through the communication hole 214. The first gas chamber 2 has a seal bearing 24. The seal bearing 24 airtightly couples the communication hole 214 and the base part 41 to each other. Accordingly, the rotary fan 4 can rotatably be supported with respect to the first gas chamber 2, and the pressure difference between the first space S1 and the second space S2 can be maintained.

### 1.4. Rotary Fan

The rotary fan 4 shown in FIGS. 1 and 2 is an axial-flow fan including the base part 41, the vane parts 42, and the first gas separation membranes 51. The axial-flow fan is a fan that generates a gas flow along an extending direction (the z-axis direction) of the rotation axis AR.

### 1.4.1. Base Part

The base part 41 has a cylindrical shape extending along the rotation axis AR. An end portion at the z-axis positive side of the base part 41 is closed. The inside of the base part 41 that is hollowed communicates with the second space S2. The base part 41 has rigidity necessary for supporting the vane parts 42, rigidity enough to withstand a pressure difference between the first space S1 and the second space S2, and sufficient airtightness. A constituent material of the base part 41 is not particularly limited, and examples thereof include a resin material, a metal material, and a ceramic material. In addition, a composite material containing these materials may be used.

### 1.4.2. Vane Part

The vane part 42 extends in a direction crossing the rotation axis AR and has a plate shape. The vane part 42 is hollow. Openings are provided in a surface (first surface) at the z-axis positive side and a surface (second surface) at the z-axis negative side of the vane part 42. The first gas separation membrane 51 is disposed so as to close the opening. The inside of the vane part 42 that is hollowed communicates with the second space S2 via the inside of the base part 41. The vane part 42 has rigidity and airtightness sufficient to withstand the pressure difference between the first space S1 and the second space S2. A constituent material of the vane part 42 is not particularly limited, and examples thereof include a resin material, a metal material, and a ceramic material. In addition, a composite material containing these materials may be used.

The vane part 42 may be integrated with the base part 41 but is preferably detachable from the base part 41. Accordingly, in the maintenance of the rotary fan 4, the vane part 42 can easily be removed and attached, and thus the maintainability is improved.

As shown in FIG. 2, the vane part 42 has a trapezoidal shape when viewed along the rotation axis AR. In the vane part 42, an upper base (a base end of the vane part 42) of the trapezoid is coupled to a side surface of the base part 41, and a lower base (a tip of the vane part 42) is a free end. The shape of the vane part 42 is not limited to a trapezoid and may be another shape.

The number of the vane parts 42 of the rotary fan 4 may be one, but is preferably two or more, more preferably 4 or more and 100 or less, and still more preferably 6 or more and 20 or less. By providing the plurality of vane parts 42, it is possible to realize the gas separation apparatus 1 in which the gas permeation amount of carbon dioxide is particularly large. When the number of the vane parts 42 is less than the lower limit value, the gas permeation amount of carbon dioxide may decrease. On the other hand, although the number of the vane parts 42 may exceed the upper limit value, the weight of the rotary fan 4 may increase and the energy required for the rotation may increase.

In FIG. 2, eight vane parts 42 are arranged at regular intervals around the rotation axis AR. When viewed along the rotation axis AR, the vane parts 42 may overlap each other, but the vane parts 42 are preferably shifted from each other. This makes it difficult for the gas flow to stagnate in the z-axis direction. In addition, when the mixed gas G1 is supplied from the z-axis positive side, it is possible to uniformly ensure an opportunity of the contact between the mixed gas G1 and the first gas separation membrane 51. As a result, the separation efficiency of carbon dioxide in each of the first gas separation membranes 51 can sufficiently be increased.

The outer diameter D of the rotary fan 4 is not particularly limited but is preferably 50 mm or more and 5000 mm or less, and more preferably 200 mm or more and 1000 mm or less. This makes it possible to optimize the balance between the energy required for the rotation of the rotary fan 4 and the gas permeation amount of the carbon dioxide in the rotary fan 4.

The thickness t of the vane part 42 is appropriately set according to the size of the vane part 42 and so on, and is not particularly limited, but is preferably 0.1 mm or more and 200 mm or less, more preferably 0.5 mm or more and 100 mm or less, and further more preferably 1 mm or more and 30 mm or less. Accordingly, it is possible to optimize balance between the energy required for the rotation of the rotary fan 4 and the rigidity of the vane part 42.

The vane part 42 may extend from the base part 41 toward the r-axis positive side, but preferably extends so that the first gas separation membrane 51 is inclined with respect to the rotation axis AR. Specifically, when the first gas separation membrane 51 is cut along a plane including the rotation axis AR, an angle θ (angle at the second space S2 side) between the rotation axis AR and the cutting surface of the first gas separation membrane 51 may be 90° but is preferably more than 0° and less than 90°. That is, in the example shown in FIG. 1, the tip of the vane part 42 is displaced toward the z-axis negative side from the base end thereof. Accordingly, when the vane part 42 rotates around the rotation axis AR, it is possible to more strongly generate the gas flow directed to the z-axis negative side in the first space S1. As a result, the mixed gas G1 having a low carbon dioxide concentration can be ejected to the r-axis positive side and moved to the mixed gas discharge port 23, and the fresh mixed gas G1 having a high carbon dioxide concentration can be drawn into the rotary fan 4.

The angle θ between the rotation axis AR and the cutting surface of the first gas separation membrane 51 is more preferably 20° or more and 80° or less, and still more preferably 30° or more and 70° or less.

The vane part 42 sufficiently have a plate shape and may have either a flat plate shape or a curved plate shape. The vane parts 42 may be twisted around the r axis shown in FIG. 2. Specifically, the vane part 42 may be disposed so that the normal line of the surface of the first gas separation membrane 51 and the rotation axis AR cross each other or may be disposed so as to have a skew relationship with each other. In the latter case, it is possible to generate the gas flow having a larger volume by optimizing the direction and angle of the skew.

### 1.4.3. First Gas Separation Membrane

The first gas separation membrane 51 separates the inside and the outside of the vane part 42 and allows the mixed gas G2 having a higher carbon dioxide concentration than the mixed gas G1 to permeate therethrough. When the rotary fan 4 rotates, the first gas separation membrane 51 moves in the mixed gas G1. At this time, in the first gas separation membrane 51, the carbon dioxide at the first space S1 side is preferentially permeated over the gas component other than the carbon dioxide contained in the mixed gas G1 to be separated toward the second space S2. Accordingly, although the concentration of the carbon dioxide at the first space S1 side decreases, the vane part 42 moves to a region where the concentration of the carbon dioxide in the mixed gas G1 does not decrease, that is, a region where the fresh mixed gas G1 exists, and thus it is possible to suppress the decrease in the concentration of the carbon dioxide on the surface at the first space S1 side of the first gas separation membrane 51. As a result, a decrease in the separation efficiency of carbon dioxide in the first gas separation membrane 51 can be suppressed. Note that the fresh mixed gas G1 refers to the mixed gas G1 in which the concentration of carbon dioxide has hardly decreased and has the initial concentration.

Two pieces of the first gas separation membranes 51 are provided to each of the vane parts 42 shown in FIG. 1. The number of the first gas separation membranes 51 provided to each of the vane parts 42 may be one but is preferably two or more. By providing the plurality of the first gas separation membranes 51, the gas separation apparatus 1 in which the gas permeation amount of carbon dioxide is particularly large can be realized.

When the plurality of the first gas separation membranes 51 are provided, the first t gas separation membranes 51 may have respective configurations the same as each other or different from each other.

The first gas separation membrane 51 allows the carbon dioxide contained in the mixed gas G1 supplied to the first space S1 side to permeate to the second space S2 side selectively or preferentially over other gas components. Accordingly, the first gas separation membrane 51 has a property that the gas permeability to carbon dioxide is higher than the gas permeability to non-target components (property that the gas selectivity of carbon dioxide is high). Hereinafter, a ratio of the gas permeability to carbon dioxide with respect to the gas permeability to nitrogen is simply referred to as “gas selectivity.”

The gas selectivity of the first gas separation membrane 51 is preferably 3 or more, and more preferably 10 or more and 1000 or less. When the gas selectivity is within the above range, the first gas separation membrane 51 can efficiently separate and recover carbon dioxide in the mixed gas G1.

The gas permeability to nitrogen in the first gas separation membrane 51 and the gas permeability to carbon dioxide in the first gas separation membrane 51 are each measured according to the gas permeability test method (first part: differential pressure method) defined in JIS K 7126-1:2006. A gas permeability measuring device is used for the measurement. Examples of the gas permeability measuring device include GTR-11A/31A manufactured by GTR TEC Corporation. In this apparatus, the gas that has permeated through the first gas separation membrane 51 is introduced into the gas chromatograph to measure the gas permeability to each component.

In the first gas separation membrane 51, the gas permeability to carbon dioxide is preferably 1000 GPU or more, more preferably 5000 GPU or more and 100000 GPU or less, and still more preferably 10000 GPU or more and 50000 GPU or less. Accordingly, it is possible to realize the first gas separation membrane 51 capable of reducing the input amount of energy necessary for the separation, specifically, reducing the pressure difference between the first space S1 side and the second space S2 side. When the gas permeability to carbon dioxide of the first gas separation membrane 51 is lower than the lower limit value, a large amount of energy is required for the separation of the carbon dioxide, and there is a possibility that economic efficiency in operation of the gas separation apparatus 1 is reduced. On the other hand, when the gas permeability to carbon dioxide of the first gas separation membrane 51 exceeds the upper limit value, the cost for manufacturing the first gas separation membrane 51 may increase. The 1 GPU is 3.35×10⁻¹⁰ mol·m⁻²·s⁻¹·Pa⁻¹.

FIG. 3 is a graph showing a relationship between the gas permeability to carbon dioxide of the first gas separation membrane 51 and the concentration of carbon dioxide on the surface of the first gas separation membrane 51 at the first space S1 side. In the graph shown in FIG. 3, the concentration of carbon dioxide when the flow velocity of the mixed gas G1 supplied onto the surface at the first space S1 side was zero, and one second elapsed from the supply of the mixed gas G1 is plotted. The gas selectivity of the first gas separation membrane 51 is assumed to be infinite.

As is clear from FIG. 3, when the gas permeability to the carbon dioxide of the first gas separation membrane 51 is 1000 GPU or more, the concentration of the carbon dioxide rapidly decreases. Therefore, when the gas permeability is 1000 GPU or more, the concentration of carbon dioxide on the surface at the first space S1 side is particularly important in order to increase the separation efficiency of carbon dioxide in the first gas separation membrane 51.

The thickness of the first gas separation membrane 51 is not particularly limited, but is preferably 1 nm or more and 1000 μm or less, more preferably 5 nm or more and 100 μm or less, and still more preferably 10 nm or more and 10 μm or less.

The average thickness of the first gas separation membrane 51 is an average value of the thicknesses measured at 10 locations in the first gas separation membrane 51. The thickness of the first gas separation membrane 51 can be measured using, for example, a thickness gauge.

The size of the first gas separation membrane 51 is not particularly limited, but the maximum length is preferably 5 cm or more and 2 m or less, and more preferably 10 cm or more and 1 m or less. As a result, the first gas separation membrane 51 having a mechanical strength enough to withstand the pressure difference and capable of ensuring a sufficient gas permeation amount is obtained.

The first gas separation membrane 51 may be a single layer or a composite layer formed by stacking a plurality of layers. When the composite layer is adopted, the first gas separation membrane 51 may include a porous layer that is porous.

Examples of a constituent material of the first gas separation membrane 51 include a polymer material, a ceramic material, and a metal material. The constituent material of the first gas separation membrane 51 may be a composite material of these materials or a composite material of these materials and other materials.

Examples of the polymer material include polyolefin resins such as polyethylene and polypropylene, fluorine-containing resins such as polytetrafluoroethylene, polyvinyl fluoride, and polyvinylidene fluoride, organopolysiloxane (silicone resin), polystyrene, cellulose, cellulose acetate, polyurethane, polyacrylonitrile, polyphenylene oxide, polysulfone, polyethersulfone, polyimide, polyaramid, and nylon.

Examples of the ceramic material include alumina, cordierite, mullite, silicon carbide, and zirconia. Examples of the metal material include stainless steel.

### 1.4.4. Second Gas Separation Membrane

The second gas separation membrane 52 separates the first space S1 side and the second space S2 side from each other, and allows the carbon dioxide (predetermined gas component) contained in the mixed gas G1 to permeate preferentially over gas components other than carbon dioxide. When the rotary fan 4, which is an axial-flow fan, rotates, the mixed gas G1 moves in the extending direction (z-axis direction) of the rotation axis AR in the first space S1. The second gas separation membrane 52 is provided at the leeward in the gas flow generated by the rotary fan 4. In the configuration illustrated in FIG. 1, the z-axis negative side of the vane part 42 is leeward. The gas exchange efficiency on the surface of the second gas separation membrane 52 is enhanced by the gas flow. Accordingly, even when the concentration of carbon dioxide on the surface of the second gas separation membrane 52 at the first space S1 side decreases, it is possible to particularly suppress the decrease in the separation efficiency of carbon dioxide in the second gas separation membrane 52.

The arrangement of the second gas separation membrane 52 is preferably leeward, but is not limited thereto, and may be a position other than leeward.

The description of the first gas separation membrane 51 described above is also applicable to the second gas separation membrane 52.

The second gas separation membrane 52 may be provided as necessary and may be omitted.

### 1.5. Drive Unit

The gas separation apparatus 1 includes a drive unit 6 disposed inside the second space S2. The drive unit 6 generates driving force for rotating the rotary fan 4. Since the driving force required for the rotation of the rotary fan 4 can be relatively small, the energy consumption of the gas separation apparatus 1 can be suppressed. Accordingly, the gas separation apparatus 1 can improve the separation efficiency of carbon dioxide while achieving energy saving.

The drive unit 6 shown in FIG. 1 includes a motor 61 and a transmission belt 62. The motor 61 rotates a shaft 612. The transmission belt 62 is suspended between the shaft 612 and the base part 41 and transmits the driving force to rotate the rotary fan 4.

The drive unit 6 may include a speed reducer and so on in addition to the above-described elements. Some or all of the elements constituting the drive unit 6 may be omitted. For example, the motor 61 may be disposed outside the second space S2.

### 2. Second Embodiment

Next, a gas separation apparatus according to a second embodiment will be described.

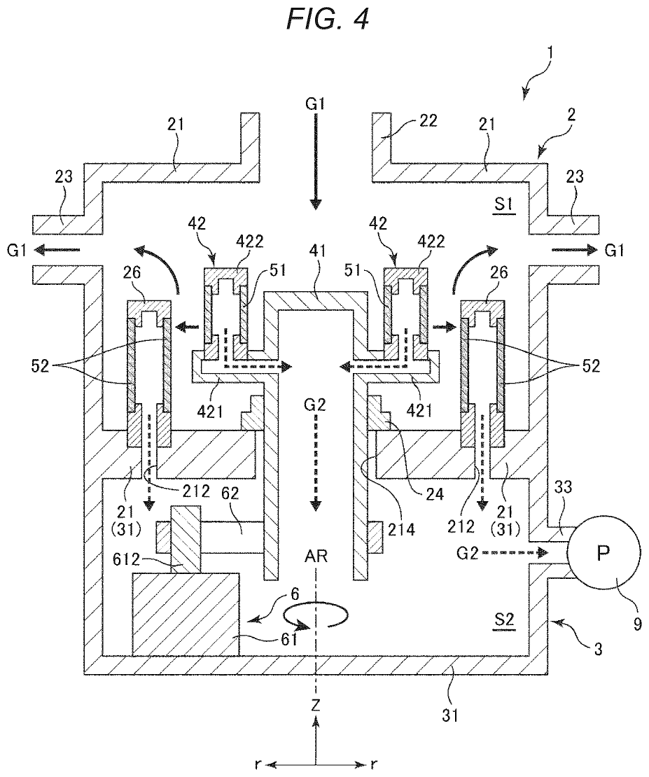

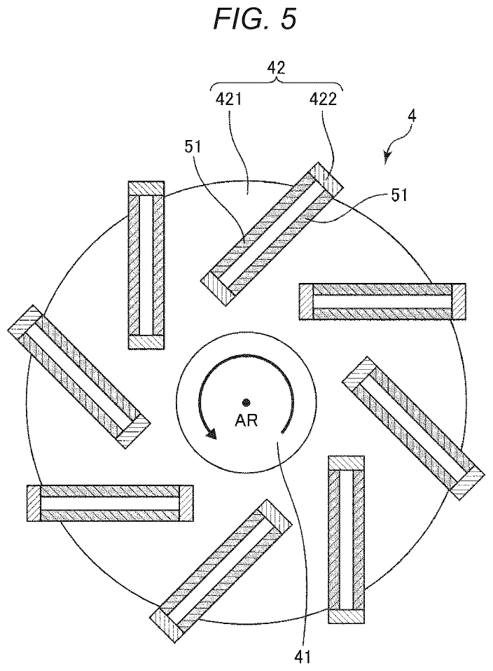

FIG. 4 is a cross-sectional view illustrating a configuration of the gas separation apparatus 1 according to the second embodiment. FIG. 5 is a cross-sectional view illustrating the rotary fan 4 provided to the gas separation apparatus 1 in FIG. 4.

Hereinafter, the second embodiment will be described, and in the following description, differences from the first embodiment will mainly be described, and description of similar matters will be omitted. Note that, in FIGS. 4 and 5, substantially the same configurations as those of the first embodiment are attached with the same reference symbols.

The second embodiment is substantially the same as the first embodiment except for the configuration of the rotary fan 4.

The rotary fan 4 shown in FIGS. 4 and 5 is a centrifugal fan having the base part 41, the vane parts 42, and the first gas separation membranes 51. The centrifugal fan is a fan that generates a gas flow along the radial direction (r-axis direction) of the rotation axis AR. This gas flow promotes the movement of the mixed gas G1 from the mixed gas supply port 22 toward the z-axis negative side. Accordingly, the fresh mixed gas G1 can be drawn into the rotary fan 4.

The base part 41 shown in FIG. 4 has a cylindrical shape extending along the rotation axis AR. An end portion at the z-axis positive side of the base part 41 is closed. The inside of the base part 41 that is hollowed communicates with the second space S2.

The vane part 42 illustrated in FIGS. 4 and 5 includes a circular plate part 421 flared from the base part 41 toward the r-axis positive side and wing pieces 422 extending from the circular plate part 421 toward the z-axis positive side. The circular plate part 421 and the wing pieces 422 are made hollow. The circular plate part 421 may be integrated with the base part 41 but is preferably attached detachably to the base part 41. The wing pieces 422 may be integrated with the circular plate part 421 but is preferably attached detachably to the circular plate part 421. Accordingly, in the maintenance of the rotary fan 4, the circular plate part 421 and the wing pieces 422 can easily be removed or attached, and thus the maintainability is improved.

The first gas chamber 2 shown in FIG. 4 has an outer wall 26. The outer wall 26 has a cylindrical shape continuous along the circumferential direction around the rotation axis AR. The outer wall 26 is hollow. The inside of the outer wall 26 communicates with the second space S2 via communication holes 212 penetrating the first wall part 21 and the second wall part 31.

Openings are provided to each of a surface at the r-axis positive side and a surface at the r-axis negative side of the outer wall 26. The second gas separation membranes 52 are disposed so as to close the openings. The second gas separation membranes 52 shown in FIG. 4 are disposed at the leeward in the gas flow generated by the rotary fan 4. In the configuration illustrated in FIG. 4, the r-axis positive side of the vane part 42 is the leeward side. The gas flow can increase the gas exchange efficiency on the surface of the second gas separation membrane 52. Accordingly, even when the concentration of carbon dioxide on the surface of the second gas separation membrane 52 at the first space S1 side decreases, it is possible to particularly suppress the decrease in the separation efficiency of carbon dioxide in the second gas separation membrane 52.

The outer wall 26 may be integrated with the first wall part 21 but is preferably attached detachably to the first wall part 21. This facilitates maintenance of the outer wall 26.

The number of the wing pieces 422 provided to the vane part 42 in FIGS. 4 and 5 may be one, but is preferably two or more, more preferably 4 or more and 100 or less, and further preferably 6 or more and 20 or less. By providing the plurality of wing pieces 422, it is possible to realize the gas separation apparatus 1 in which the gas permeation amount of carbon dioxide is particularly large. When the number of the wing pieces 422 is less than the lower limit value, the gas permeation amount of the carbon dioxide may decrease. On the other hand, although the number of the wing pieces 422 may exceed the upper limit value, the weight of the rotary fan 4 may increase and the energy required for the rotation may increase.

In FIG. 5, eight wing pieces 422 are arranged at regular intervals around the rotation axis AR. Two pieces of the first gas separation membranes 51 are provided to each of the wing pieces 422 shown in FIG. 5. The number of the first gas separation membranes 51 provided to each of the wing pieces 422 may be one but is preferably two or more. By providing the plurality of the first gas separation membranes 51, the gas separation apparatus 1 in which the gas permeation amount of carbon dioxide is particularly large can be realized.

In such the second embodiment as described above, substantially the same effects as those of the first embodiment can also be obtained.

The arrangement of the mixed gas supply port 22 and the mixed gas discharge port 23 is appropriately changed according to the configuration of the rotary fan 4. For example, in the present embodiment, the rotary fan 4 is configured to generate the gas flow directed from the rotation axis AR to the r-axis positive side but may be configured to generate a gas flow directed in the opposite direction (gas flow directed from the r-axis positive side to the rotation axis AR). In the latter case, the arrangement of the mixed gas supply port 22 and the mixed gas discharge port 23 may be opposite to that of the present embodiment, that is, the mixed gas discharge port 23 may be disposed on the extension line of the rotation axis AR and the mixed gas supply port 22 may be disposed on the radius of the rotation axis AR.

### 3. Third Embodiment

Next, a gas separation apparatus according to a third embodiment will be described.

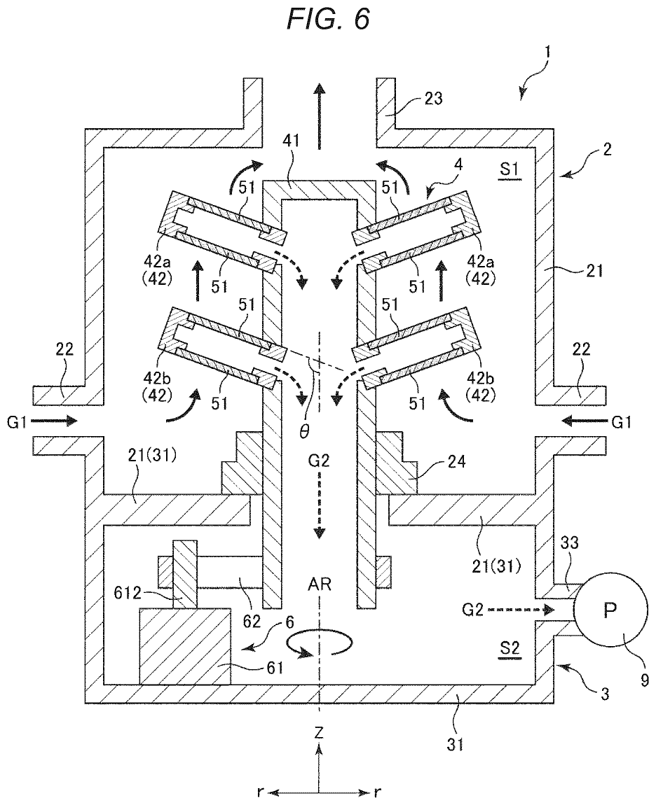

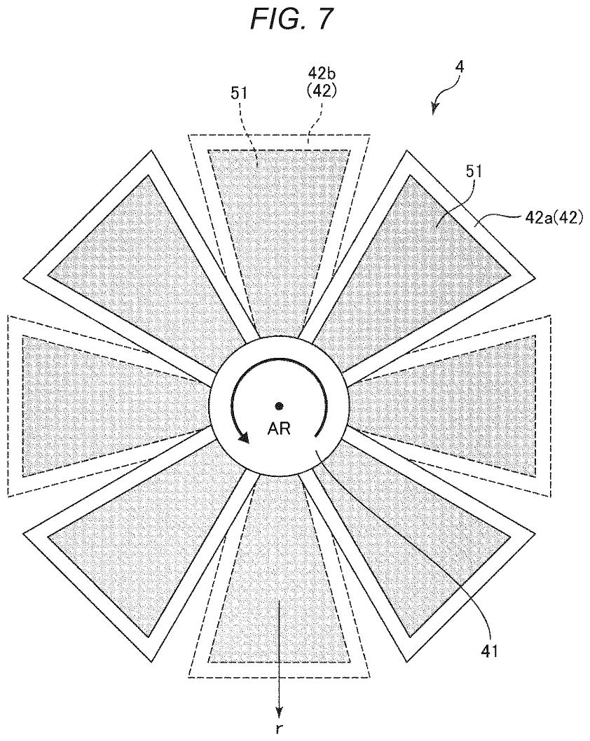

FIG. 6 is a cross-sectional view illustrating a configuration of the gas separation apparatus 1 according to the third embodiment. FIG. 7 is a plan view illustrating the rotary fan 4 provided to the gas separation apparatus 1 in FIG. 6.

Hereinafter, the third embodiment will be described, and in the following description, differences from the first embodiment will be mainly described, and description of similar matters will be omitted. Note that, in FIGS. 6 and 7, substantially the same configurations as those of the first embodiment are attached with the same reference symbols.

The third embodiment is substantially the same as the first embodiment except for the configuration of the rotary fan 4.

The rotary fan 4 shown in FIGS. 6 and 7 is an axial-flow fan including the base part 41, the vane parts 42, and the first gas separation membranes 51.

The base part 41 shown in FIG. 6 has a cylindrical shape extending along the rotation axis AR. An end portion at the z-axis positive side of the base part 41 is closed. The inside of the base part 41 that is hollowed communicates with the second space S2.

In the vane part 42 illustrated in FIG. 6, when the first gas separation membrane 51 is cut along a plane including the rotation axis AR, an angle θ (an angle at the second space S2 side) between the rotation axis AR and a cutting surface of the first gas separation membrane 51 is different from that in FIG. 1. Specifically, the angle θ shown in FIG. 6 is more than 90° and less than 180°. That is, in the example shown in FIG. 6, the tip of the vane part 42 is displaced toward the z-axis positive side from the base end thereof. Accordingly, when the vane part 42 rotates around the rotation axis AR, it is possible to more strongly generate the gas flow directed toward the z-axis positive side in the first space S1. As a result, the mixed gas G1 having a low carbon dioxide concentration can be moved to the mixed gas discharge port 23, and the fresh mixed gas G1 having a high carbon dioxide concentration can be drawn into the rotary fan 4.

In the first gas chamber 2 shown in FIG. 6, the direction of the gas flow of the mixed gas G1 is opposite to that in the first gas chamber 2 shown in FIG. 1. In the first gas chamber 2 shown in FIG. 6, the mixed gas supply port 22 is disposed in a region in the first wall part 21 at the r-axis positive side of the rotary fan 4 (on the radius of the rotation axis AR). Accordingly, the fresh mixed gas G1 can efficiently be drawn into the first space S1. In addition, in the first gas chamber 2 illustrated in FIG. 6, the mixed gas discharge port 23 is disposed in a region in the first wall part 21 at the z-axis positive side of the rotary fan 4 (on an extension line of the rotation axis AR). As a result, the mixed gas G1 in which the concentration of the carbon dioxide is reduced can efficiently be discharged to the outside of the first space S1 due to the gas flow by the rotary fan 4.

The vane part 42 shown in FIG. 6 includes four vane parts 42a and four vane parts 42b located at the z-axis negative side of the vane parts 42a. That is, in the rotary fan 4 shown in FIG. 6, the four vane parts 42a and the four vane parts 42b are arranged to be shifted from each other in the z-axis direction. In such a configuration, the gas flow generated in the vane part 42b can be applied to the vane part 42a. Accordingly, the gas exchange efficiency of the mixed gas G1 can particularly be increased on the surface of the first gas separation membrane 51 provided to the vane part 42a.

In the rotary fan 4 illustrated in FIG. 7, the vane parts 42 are displaced from each other when viewed along the rotation axis AR. In particular, in FIG. 7, the vane parts 42a are shifted from each other, the vane parts 42b are shifted from each other, and in addition, the vane parts 42a are shifted from the vane parts 42b. This makes it difficult for the gas flow to stagnate in the z-axis direction.

In such the third embodiment described above, substantially the same advantages as those of the first embodiment are also obtained.

### 4. Fourth Embodiment

Next, a gas separation apparatus according to a fourth embodiment will be described.

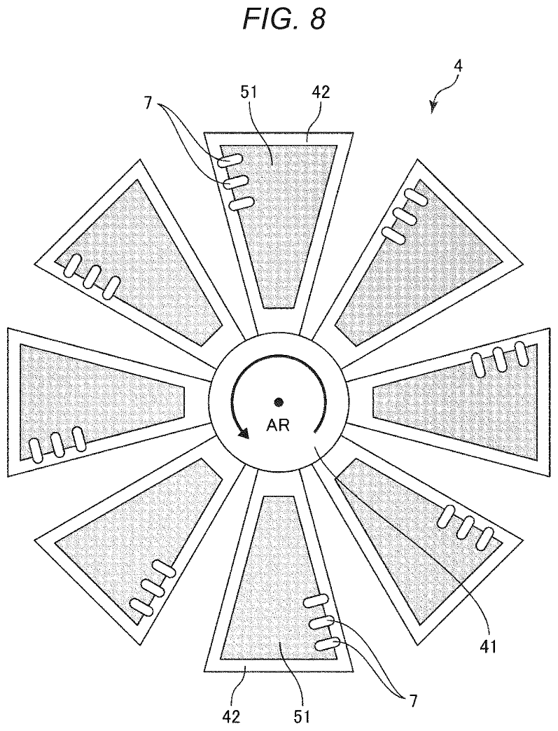

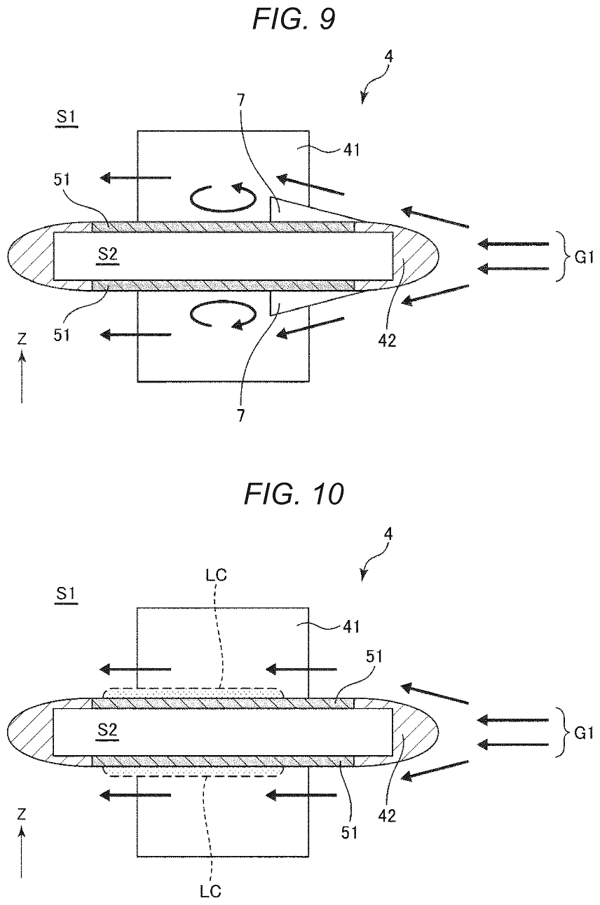

FIG. 8 is a plan view illustrating the rotary fan 4 provided to the gas separation apparatus 1 according to the fourth embodiment. FIG. 9 is a schematic diagram in which an example of the flow of the mixed gas G1 is added to a cross-sectional view of the vane part 42 shown in FIG. 8. FIG. 10 is a schematic diagram in which an example of the flow of the mixed gas G1 is added to a cross-sectional view of a model (model of a related-art example) in which convex structures 7 illustrated in FIG. 9 are omitted.

Hereinafter, the fourth embodiment will be described, and in the following description, differences from the first embodiment will mainly be described, and descriptions of substantially the same matters will be omitted. In FIGS. 8 to 10, substantially the same components as those of the first embodiment are denoted by the same reference symbols.

The fourth embodiment is substantially the same as the first embodiment except for the configuration of the rotary fan 4.

The rotary fan 4 illustrated in FIG. 8 includes the convex structures 7. The convex structures 7 are each a region protruding from the surface of the first gas separation membrane 51. In FIGS. 8 and 9, the convex structure 7 is provided on the surface of the first gas separation membrane 51, but the convex structure 7 is not limited thereto. For example, it may be a region protruding from the surface of the vane part 42 or may be a region protruding from both the surface of the vane part 42 and the surface of the first gas separation membrane 51. The convex structure 7 causes turbulence to the gas flow formed on the surface of the vane part 42 and the surface of the first gas separation membrane 51. This turbulence acts to replenish the fresh mixed gas G1 to the surface of the first gas separation membrane 51. Accordingly, the concentration of carbon dioxide on the surface of the first gas separation membrane 51 can be maintained high, and the decrease in separation efficiency can be suppressed.

On the other hand, as shown in FIG. 10, when the convex structures 7 are omitted, the gas flow of the mixed gas G1 becomes a laminar flow flowing along the surface of the vane part 42 and the surface of the first gas separation membrane 51. In this specification, the term “laminar flow” refers to a gas flow flowing in parallel to a surface of an object. The flow velocity of the laminar flow tends to decrease in a direction toward the surface of the object. Therefore, in the vicinity of the surface of the first gas separation membrane 51, the gas exchange efficiency of the mixed gas G1 decreases, and the concentration of carbon dioxide decreases. In FIG. 10, a region where the concentration of carbon dioxide is low is referred to as a “low-concentration region LC,” and dots are added. When such the low-concentration region LC is generated, the first gas separation membrane 51 does not sufficiently function, and the separation efficiency of carbon dioxide decreases.

In contrast, when the convex structure 7 is provided, as shown in FIG. 9, a part of the gas flow of the mixed gas G1 hits the convex structure 7 to generate the turbulence at the downstream. The turbulence includes, for example, a flow of agitating the mixed gas G1 in the Z-axis direction. Therefore, at the downstream of the convex structure 7, the fresh mixed gas G1 is apt to be supplied, and an advantage that the concentration of carbon dioxide is hardly decreased is obtained. As a result, in the rotary fan 4 shown in FIG. 9, the generation of such the low-concentration region LC as shown in FIG. 10 is suppressed, and the decrease in the separation efficiency of carbon dioxide can be suppressed.

The shape, the material, the arrangement, and so on of the convex structure 7 are not particularly limited as long as the convex structure 7 is a member that generates such a turbulence as described above. In FIG. 8, three pieces of the convex structures 7 are provided to both surfaces of each of the vane parts 42. The number of the convex structures 7 provided to each of the vane parts 42 may be one or more. By providing the plurality of convex structures 7, it is possible to generate the turbulence in respective parts of the first gas separation membrane 51. As a result, the decrease in the separation efficiency of carbon dioxide can particularly be suppressed.

### 5. Advantages of Embodiments

As described above, the gas separation apparatus 1 according to the embodiments described above includes the first gas chamber 2, the second gas chamber 3, and the rotary fan 4.

The first gas chamber 2 includes the first wall part 21, a mixed gas supply port 22, and a mixed gas discharge port 23. The first wall part 21 defines the first space S1. The mixed gas supply port 22 is provided to the first wall part 21 and supplies the mixed gas G1 into the first space S1. The mixed gas discharge port 23 discharges the mixed gas G1 from the inside of the first space S1 to the outside.

The second gas chamber 3 has the second wall part 31 and a gas component discharge port 33. The second wall part 31 defines the second space S2. The gas component discharge port 33 is provided to the second wall part 31 and discharges the gas (mixed gas G2) containing the carbon dioxide (predetermined gas component) extracted from the mixed gas G1 from the inside of the second space S2 to the outside. That is, the gas component discharge port 33 discharges the gas obtained by allowing the carbon dioxide contained in the mixed gas G1 to permeate preferentially over the other gas components.

The rotary fan 4 includes the base part 41 that is hollowed, the vane parts 42 that are hollowed, and the first gas separation membranes 51. The base part 41 rotates around the rotation axis AR, and the inside thereof communicates with the second space S2. The vane part 42 is disposed in the first space S1, and the inside thereof communicates with the second space S2. The first gas separation membrane 51 separates the inside and the outside of the vane part 42 and allows the gas (mixed gas G2) having the higher carbon dioxide concentration than the mixed gas G1 to permeate therethrough.

According to such a configuration, even when the concentration of the carbon dioxide on the surface decreases due to the action of the first gas separation membrane 51, the first gas separation membrane 51 provided to the vane part 42 moves to the region where the fresh mixed gas G1 exists, and thus it is possible to suppress the decrease in the concentration of carbon dioxide on the surface of the first gas separation membrane 51. As a result, the gas separation apparatus 1 capable of suppressing the decrease in the separation efficiency of the carbon dioxide in the first gas separation membrane 51 is obtained.

The gas separation apparatus 1 according to the embodiments includes the drive unit 6 that rotates the rotary fan 4.

According to such a configuration, it is possible to realize the gas separation apparatus 1 in which the separation efficiency of carbon dioxide is improved while realizing energy saving.

In addition, in the gas separation apparatus 1 according to the embodiments, the vane part 42 has the plate shape having the surface at the z-axis positive side (first surface) and the surface at the z-axis negative side (second surface). The first gas separation membrane 51 is disposed on each of the surface at the z-axis positive side and the surface at the z-axis negative side.

According to such a configuration, since the plurality of first gas separation membranes 51 are provided to the vane part 42, it is possible to realize the gas separation apparatus 1 in which the gas permeation amount of carbon dioxide is particularly large.

In the gas separation apparatus 1 according to the embodiments, the rotary fan 4 includes the plurality of vane parts 42 supported by the base part 41.

According to such a configuration, it is possible to realize the gas separation apparatus 1 in which the gas permeation amount of carbon dioxide is particularly large.

In the gas separation apparatus 1 according to the embodiment, the rotary fan 4 is the axial-flow fan that generates the gas flow along the extending direction of the rotation axis AR (z-axis direction).

According to such a configuration, it is possible to generate a gas flow along the z-axis (a gas flow directed to the z-axis positive side or the z-axis negative side) in the first space S1. As a result, the mixed gas G1 having a low carbon dioxide concentration can be moved to the mixed gas discharge port 23, and the fresh mixed gas G1 having a high carbon dioxide concentration can be drawn into the rotary fan 4. In addition, when the second gas separation membrane 52 is disposed at the leeward in the gas flow, the gas exchange efficiency on the surface of the second gas separation membrane 52 can be increased, and thus the decrease in the separation efficiency of carbon dioxide in the second gas separation membrane 52 can particularly be suppressed.

Further, in the gas separation apparatus 1 according to the embodiments, the vane parts 42 are displaced from each other when viewed along the rotation axis AR.

According to such a configuration, the gas flow is less likely to stagnate in the z-axis direction (the extending direction of the rotation axis AR).

In the gas separation apparatus 1 according to the embodiments, when the first gas separation membrane 51 is cut along the plane including the rotation axis AR, the angle between the rotation axis AR and the cutting surface of the first gas separation membrane 51 is greater than 0° and less than 90°.

According to such configuration, it is possible to more strongly generate the gas flow toward the z-axis negative side in the first space S1. As a result, the mixed gas G1 having a low carbon dioxide concentration can be moved to the mixed gas discharge port 23, and the fresh mixed gas G1 having a high carbon dioxide concentration can be drawn into the rotary fan 4. In addition, when the second gas separation membrane 52 is disposed at the leeward in the gas flow, the gas exchange efficiency on the surface of the second gas separation membrane 52 can be increased, and thus the decrease in the separation efficiency of carbon dioxide in the second gas separation membrane 52 can particularly be suppressed.

In the gas separation apparatus 1 according to the embodiments, the rotary fan 4 is the centrifugal fan that generates the gas flow along the radial direction (r-axis direction) of the rotation axis AR.

According to such a configuration, it is possible to generate the gas flow toward the r-axis positive side in the first space S1. As a result, the mixed gas G1 having a low carbon dioxide concentration can be moved to the mixed gas discharge port 23, and the fresh mixed gas G1 having a high carbon dioxide concentration can be drawn into the rotary fan 4. In addition, when the second gas separation membrane 52 is disposed at the leeward in the gas flow, the gas exchange efficiency on the surface of the second gas separation membrane 52 can be increased, and thus the decrease in the separation efficiency of carbon dioxide in the second gas separation membrane 52 can particularly be suppressed.

The gas separation apparatus 1 according to the embodiments includes the second gas separation membrane 52. The second gas separation membrane 52 is provided at the leeward in the gas flow generated by the rotary fan 4, separates the first space S1 and the second space S2, and allows the gas (mixed gas G2) containing the carbon dioxide (predetermined gas component) extracted from the mixed gas G1 to permeate therethrough.

According to such a configuration, the gas exchange efficiency on the surface of the second gas separation membrane 52 is enhanced. Accordingly, even when the concentration of carbon dioxide on the surface of the second gas separation membrane 52 at the first space S1 side decreases, it is possible to particularly suppress the decrease in the separation efficiency of carbon dioxide in the second gas separation membrane 52.

The gas separation apparatus 1 according to the embodiments includes the exhaust pump 9 coupled to the gas component discharge port 33.

According to such a configuration, the second space S2 can be depressurized, and the carbon dioxide (predetermined gas component) contained in the mixed gas G1 can be preferentially separated over the gas component other than carbon dioxide contained in the mixed gas G1.

The gas permeability to carbon dioxide of the first gas separation membrane 51 is preferably 5000 GPU or more and 100000 GPU or less.

According to such a configuration, it is possible to realize the first gas separation membrane 51 capable of reducing the input amount of energy necessary for the separation, specifically, reducing the pressure difference between the first space S1 side and the second space S2 side.

In the gas separation apparatus 1 according to the embodiments, the mixed gas supply port 22 is disposed on the extension line of the rotation axis AR, and the mixed gas discharge port 23 is disposed on the radius of the rotation axis AR.

According to such a configuration, the fresh mixed gas G1 can efficiently be drawn into the first space S1 from the mixed gas supply port 22 with the gas flow generated by the rotary fan 4, and the mixed gas G1 in which the concentration of carbon dioxide is reduced can efficiently be discharged to the outside of the first space S1.

Although the gas separation apparatus according to the present disclosure is described above based on the illustrated embodiments, the present disclosure is not limited thereto.

For example, the gas separation apparatus according to the present disclosure may be what is obtained by replacing each unit of the embodiment described above with any component having the same function, or what is obtained by adding any constituent to the embodiment described above.

What is claimed is:

1. A gas separation apparatus comprising:
a first gas chamber including a first wall part configured to define a first space, a mixed gas supply port that is provided to the first wall part and configured to supply a mixed gas into the first space, and a mixed gas discharge port configured to discharge the mixed gas from the inside of the first space to an outside;
a second gas chamber including a second wall part configured to define a second space, and a gas component discharge port that is provided to the second wall part and configured to discharge a gas containing a predetermined gas component extracted from the mixed gas from an inside of the second space to an outside; and
a rotary fan including a base part that is hollowed, that is configured to rotate around a rotation axis, and that has an inside communicating with the second space, a vane part that is hollowed, that is disposed in the first space, and that has an inside communicating with the second space, and a first gas separation membrane that is configured to separate an inside and an outside of the vane part, and that allows a gas higher in concentration of the predetermined gas component than the mixed gas to permeate therethrough.

2. The gas separation apparatus according to claim 1, further comprising
a drive unit configured to rotate the rotary fan.

3. The gas separation apparatus according to claim 1, wherein
the vane part has a plate shape having a first surface and a second surface, and
the first gas separation membrane is provided to each of the first surface and the second surface.

4. The gas separation apparatus according to claim 1, wherein
the rotary fan includes a plurality of the vane parts supported by the base part.

5. The gas separation apparatus according to claim 4, wherein
the rotary fan is an axial-flow fan that is configured to generate a gas flow along an extending direction of the rotation axis.

6. The gas separation apparatus according to claim 5, wherein
the vane parts are displaced from each other when viewed along the rotation axis.

7. The gas separation apparatus according to claim 5, wherein
when the first gas separation membrane is cut along a plane including the rotation axis, an angle between the rotation axis and a cutting surface of the first gas separation membrane is more than 0° and less than 90°.

8. The gas separation apparatus according to claim 4, wherein
the rotary fan is a centrifugal fan that generates a gas flow along a radial direction of the rotation axis.

9. The gas separation apparatus according to claim 5, further comprising
a second gas separation membrane that is provided at leeward in a gas flow generated by the rotary fan, that is configured to separate the first space and the second space from each other, and that is configured to allow a gas containing the predetermined gas component extracted from the mixed gas to permeate therethrough.

10. The gas separation apparatus according to claim 1, further comprising
an exhaust pump coupled to the gas component discharge port.

11. The gas separation apparatus according to claim 1, wherein
a gas permeability to carbon dioxide of the first gas separation membrane is 5000 GPU or more and 100000 GPU or less.

12. The gas separation apparatus according to claim 1, wherein
the mixed gas supply port is disposed on an extension line of the rotation axis, and
the mixed gas discharge port is disposed on a radius of the rotation axis.
